(19) United States
(12) Patent Application Publication
(10) Pub. No.: US 2023/0242789 A1
(43) Pub. Date: Aug. 3, 2023

(54) PROCESS FOR PRODUCING COATING COMPOSITION

(71) Applicant: Stora Enso OYJ, Helsinki (FI)

(72) Inventors: Ashar Zafar, Älta (SE); Katarina Hägg, Bromma (SE); David Almqvist, Tryesö (SE); Dimitri Areskogh, Bromma (SE)

(73) Assignee: Stora Enso OYJ, Helsinki (FI)

(21) Appl. No.: 18/003,715

(22) PCT Filed: Jul. 1, 2021
(86) PCT No.: PCT/IB2021/055904

§ 371 Date: Dec. 29, 2022

(30) Foreign Application Priority Data
Jul. 3, 2020 (SE) 2050834-7

(51) Int. Cl. C09D 197/00; C09D 7/80; C09D 7/20; C09D 7/65

(52) U.S. Cl. CPC C09D 197/005; C09D 7/20; C09D 7/65; C09D 7/80

(57) ABSTRACT

The present invention is directed to a process for preparing coating compositions containing up to 100% bio-based content. The coating compositions are used for coating metal, paper and wood substrates in various applications. The process for preparing the coating composition comprises the steps of providing lignin, wherein the lignin is agglomerated and has a particle size distribution such that at least 80 wt-% of the agglomerates have a diameter within the range of from 0.2 mm to 5.0 mm, dissolving the agglomerated lignin in an organic solvent, and mixing the solution with a crosslinker to obtain a coating composition.

### FIELD OF THE INVENTION

The present invention is directed to a process for preparing coating compositions containing up to 100% bio-based content. The coating compositions are used for coating metal, paper and wood substrates in various applications.

### BACKGROUND

Resins used in the coating industry are mostly based on fossil based raw materials. There are concerns related to the use of fossil-based raw material because of high carbon footprints and toxicity.

It is a trend in the coating industry to improve the coating formulations so that the formulations use high content of bio-based and renewable materials. Governmental and non-governmental agencies have developed regulations and guidelines to quantify bio-based content in coatings. However, the bio-based content is still usually small and the number of bio-based products limited.

EP2935411 describes lignin-based coating formulations for protective coatings for metals that is based on lignin and various cross-linkers.

For solvent-borne coatings, it is necessary to utilize a lignin product with minimal amount of moisture to avoid bringing unnecessary additional water to the process. Since many organic solvents are not miscible with water, it is not possible to use moist lignin with an amount of moisture in the range of 30-40% (on weight basis). However, handling of lignin with a minimal moisture content of 0-5% (on weight basis) presents several issues. Among those is that the lignin during handling forms dust clouds. These dust clouds may further lead to dust explosions when sufficiently high concentration of combustible material is suspended in air.

### SUMMARY OF THE INVENTION

The present invention provides a solution to one more of the problems of the prior art. A particular advantage of the process according to the present invention is that the dust forming fines are reduced to such extent that the risk of dust explosion is significantly reduced.

Thus, the present invention is directed to a process for preparing a coating composition, comprising the steps of
providing lignin, wherein the lignin is agglomerated and has a particle size distribution such that at least 80 wt-% of the agglomerates have a diameter within the range of from 0.2 mm to 5.0 mm;
dissolving the agglomerated lignin in an organic solvent; and mixing the solution with a crosslinker to obtain a coating composition.

More specifically, the present invention is directed to a process for preparing a coating composition, comprising the steps of
a) compaction of lignin, wherein lignin having a moisture content of from 1 wt-% to 45 wt-% is agglomerated by means of roll compaction, wherein the rolls have cavities and wherein the depth of each cavity used in the roll compaction is from 0.1 mm to 10 mm;
b) subjecting the compacted lignin from step a) to a milling step; followed by
c) a sieving step, wherein the product of step b) is subjected to sieving to remove particles having a particle diameter below 100 µm, to produce a final agglomerated lignin with a controlled particle size distribution in which the particle size distribution is governed by the porosity of the sieving screens used in the sieving step; and wherein less than 10 wt-% of the particles retained after step c) have a particle diameter below 100 µm;
d) dissolving the product of step c) in an organic solvent;
e) mixing the solution of step d) with a crosslinker to obtain a coating composition.

The present invention is also directed to a coating prepared using the coating composition obtained with the process according to the present invention.

The present invention is also directed to a substrate coated with a coating composition obtained with the process according to the process of the present invention.

### DETAILED DESCRIPTION

The compaction in step a) of the present invention is preferably carried out without addition of any additives to the lignin to be compacted.

It is intended throughout the present description that the expression “lignin” embraces any kind of lignin, e.g. lignin originated from hardwood, softwood or annual plants. Preferably the lignin is an alkaline lignin generated in e.g. the Kraft process. Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%, more preferably at least 98%, most preferably at least 99%, 99.5% or 99.9%. Thus, the lignin used according to the process of the present invention preferably contains less than 10%, preferably less than 5%, more preferably less than 2% impurities. The lignin may then be separated from the black liquor by using the process disclosed in WO2006031175.

It is particularly beneficial to carry out the compaction in step a) on a material that is essentially only lignin, i.e. in the absence of additives, since that makes the use of the compacted product easier, due to the absence of binders or other components that could otherwise negatively influence the application in which the compacted, milled and sieved lignin is supposed to be used.

Preferably, the lignin is dried before compaction, i.e. before step a) of the process according to the present invention. The drying of the lignin is carried out by methods and equipment known in the art. The lignin used in step a) has a moisture content of from 1 wt-% to 45 wt-%. Preferably, the moisture content of the lignin before compaction according to the present invention is less than 25 wt-%, preferably less than 10 wt-%, more preferably less than 8 wt-%. The temperature during the drying is preferably in the range of from 80° C. to 160° C., more preferably in the range of from 100° C. to 120° C.

The lignin powder obtained after drying has a wide particle size distribution ranging from 1 µm to 2 mm which is significantly skewed towards the micrometer range, meaning that a significant proportion of the particles has a diameter in the range of 1 to 200 micrometers. It is known in the art that there is a strong correlation between explosivity characteristics and particle size distribution exists (BIA-Report 13/97 Combustion and explosion characteristics of dusts), that is, the smaller the particles, the more severe is the risk of explosion. The particles below a diameter of 100 micrometers are here considered as fines.

The roll compaction of lignin can be achieved by a roller compactor to agglomerate the lignin particles. The present invention is a process comprising three steps: compaction, milling and sieving.

In the compaction step a), a first intermediate product is generated. Here, the fine lignin powder is usually fed through a hopper and conveyed by means of a horizontal or vertical feeding screw into the compaction zone where the material is compacted into flakes by compaction rollers with a defined gap. By controlling the feeding screw speed, the pressure development in the compaction zone, flakes with uniform density can be obtained. The pressure development in the compaction zone can preferably be monitored and controlled by the rotational speed of the compaction rolls. As the powder is dragged between the rollers, it enters what is termed as the nip area where the density of the material is increased and the powder is converted into a flake or ribbon. The rolls used have cavities. The depth of each cavity used in the roll compaction is from 0.1 mm to 10 mm, preferably from 1 mm to 8 mm, more preferably from 1 mm to 5 mm or from 1 mm to 3 mm. The specific press force exerted during the compaction may vary depending on the equipment used for compaction, but may be in the range of from 1 kN/cm to 100 kN/cm. Equipment suitable for carrying out the compaction are known in the art.

Preferably, the lignin used in step a) is provided in the form of a powder having a particle size distribution such that at least 25 wt-% of the lignin has a particle diameter of from 1 µm to 100 µm.

In the milling step b) of the process, the first intermediate product from the compaction step is subjecting to milling or grinding, such as by means of rotary granulator, cage mill, beater mill, hammer mill or crusher mill and or combinations thereof. During this step, a secondary intermediate product is generated.

In the sieving step c) of the process, the secondary intermediate product from the milling step b) is screened by means of physical fractionation such as sieving, also referred to as screening, to obtain a final product which is agglomerated lignin with a defined particle size distribution set by the porosity of the sieves or screens in this step. The sieve or screen is selected such that most particles having a diameter below 100 µm pass through the screen and are rejected and preferably returned to the compaction step, whereas most particles having a diameter above 100 µm are retained and are the product of the sieving step and of the process according to the present invention. The sieving may be carried out in more than one step, i.e. the sieving can be carried out such that the crushed material from step b) passes sequentially through more than one screen or sieve. By using a screening stage with two or more different screen porosities, several fractions with more defined particle size distribution are obtained.

In one embodiment, the rolls configuration is such that the first roll has an annual rim in such configuration so that the powder in the nip region is sealed in the axial direction along the roller surface.

In one embodiment, the roll configuration is such that the nip region is sealed in the axial direction along the roller surface with a static plate.

By ensuring that the nip region is sealed, loss of powder at the axial ends of the rollers is minimized as compared to entirely cylindrical nip rollers.

The lignin obtained in step c) preferably has a particle size distribution such that at least 80 wt-% of the agglomerates have a diameter within the range of from 0.2 mm to 5.0 mm, more preferably at least 80 wt-% of the agglomerates have a diameter within the range of from 0.2 mm to 2.0 mm.

As used herein, the term organic solvent means a carbon-based substance that is used to dissolve another substance or substances. Since the organic solvent is carbon-based, it has at least one carbon atom in its structure. The organic solvent also has at least one hydrogen atom. As used herein, the organic solvent is a liquid at 25° C.

Preferably, the organic solvent used in step d) is selected from ketones (such as acetone, methyl ethyl ketone (MEK), methyl isobutyl ketone (MIBK), methyl amyl ketone (MAK), Isophrone), esters (butyl acetate, ethyl acetate, methoxy propyl acetate (MPA), butylglycol acetate), alcohols (butanol, isopropanol), glycol ethers (ethylene glycol monobutyl ether, butyl glycol ether etc.), or hydrocarbons (naphtha, xylene etc.) or ethers or mixtures thereof.

The coating composition prepared according to the present invention preferably contains less than 1 wt-% of solvent other than organic solvents, preferably less than 0.5 wt-%, more preferably 0 wt-%.

In the coating composition, the weight ratio between lignin (dry weight) and the total amount of crosslinker is preferably in the range of from 1:10 to 10:1. The amount of lignin in the bonding resin is preferably from 5 wt-% to 50 wt-%, calculated as the dry weight of lignin and the total weight of the coating composition.

The crosslinker used in step e) is preferably selected from selected from glycerol diglycidyl ether, polyglycerol diglycidyl ether, polyglycerol polyglycidyl ether, glycerol triglycidyl ether, sorbitol polyglycidyl ether, alkoxylated glycerol polyglycidyl ether, trimethylolpropane triglycidyl ether, trimethylolpropane diglycidyl ether, polyoxypropylene glycol diglycidylether, polyoxypropylene glycol triglycidyl ether, diglycidylether of cyclohexane dimethanol, resorcinol diglycidyl ether, isosorbide diglycidyl ether, pentaerythritol tetraglycidyl ether, ethylene glycol diglycidyl ether, polyethylene glycol diglycidyl ether having 2-9 ethylene glycol units, propylene glycol diglycidyl ether having 1-5 propylene glycol units, diglycidyl-, triglycidyl- or polyglycidyl- ether of a carbohydrate, diglycidyl-, triglycidyl- or polyglycidyl-ester of a carbohydrate, diglycidyl-ether or diglycidyl ester of salicylic acid, vanillic acid, or 4-hydroxybenzoic acid, an epoxidized or glycidyl substituted plant-based phenolic compound or epoxidized plant-based oil, tris(4-hydroxyphenyl) methane triglycidyl ether, N,N-bis(2,3-epoxypropyl)aniline, p-(2,3-epoxypropoxy-N,N-bis(2,3-epoxypropyl)aniline, diglycidyl ether of bis-hydroxymethylfuran, and/or diglycidyl ether of terminal diol having a linear carbon chain of 3-6 carbon atoms, and a crosslinker having functional groups selected from glycidyl amine, diglycidyl amine, triglycidyl amine, polyglycidyl amine, glycidyl amide, diglycidyl amide, triglycidyl amide, polyglycidyl amide, glycidyl ester, diglycidyl ester, triglycidyl ester, polyglycidyl ester, glycidyl azide, diglycidyl azide, triglycidyl azide, polyglycidyl azide, glycidyl methacrylate, diglycidyl methacrylate, triglycidyl methacrylate, or polyglycidyl methacrylate.

Additives can be added in step d) or e), in an amount of 1-20 wt-%, based on the weight of the coating composition. Suitable additives include tannin, solvents, surfactants, accelerator, catalyst, dispersing agents and fillers and hardeners. Examples of such fillers and/or hardeners include limestone, cellulose, sodium carbonate, and starch.

The reactivity of the lignin with the crosslinker can be increased by modifying the lignin, prior to the compaction in step a), by glyoxylation, etherification, esterification or any other method where lignin hydroxyl content or carboxylic content or amine content or thiol content is increased.

The coating compositions obtained in step e) can be applied to substrates in any manner known to those skilled in the art. In some embodiments, the coating composition is sprayed or roll coated onto the substrate. The coating composition may be pigmented and/or opacified with known pigments and opacifiers. Thus, for example, spraying, rolling, dipping, and flow coating application methods can be used for both clear and pigmented coating. Suitable substrates include metal, paper and wood.

After application onto a substrate, the coating may be cured thermally at temperatures in the range from about 20° C. to about 300° C., and alternatively higher for a time sufficient to effect complete curing.

Preferably, the coating composition and the coating is each free from formaldehyde.

### EXAMPLES

### Example 1

Granulated lignin of the particle size 0.5-1.5 mm was used to prepare a lignin solution. Lignin solution was prepared by adding 30 g of lignin granules into 70 g of ethylene glycol monobutyl ether (EGME) in a 250 mL plastic cup at ambient temperature. The lignin granules were stirred with an overhead stirrer until the lignin granules were completely dissolved.

Coating composition was prepared by weighing 50 g of the lignin solution and 15 g of polyglycerol polyglycidyl ether weighing into a 100 ml plastic cup and stirred with a wooden stick for 2 minutes. The coating formulation was applied on an aluminum metal sheet using a film applicator. Then, the metal sheet was baked in an oven at 200° C. for 10 minutes.

The cured coating was able to withstand 30 methyl ethyl ketone (MEK) double rubs, it had 100% adhesion (by cross hatch tape off method), an 1H pencil hardness and no cracking from bending the metal sheet at 0T. The coated panel was bent back on itself with the coating side out. If there was no crack at the edge, the result was reported as 0 T. After 1 hour in boiling water, the film was not blushed.

In view of the above detailed description of the present invention, other modifications and variations will become apparent to those skilled in the art. However, it should be apparent that such other modifications and variations may be effected without departing from the spirit and scope of the invention.

1. A process for preparing a coating composition, comprising the steps of:
providing lignin, wherein the lignin is agglomerated and has a particle size distribution such that at least 80 wt-% of the agglomerated lignin has a diameter within a range of from 0.2 mm to 5.0 mm;
dissolving the agglomerated lignin in an organic solvent to form a solution; and
mixing the solution with a crosslinker to obtain a coating composition.

2. The process according to claim 1, further comprising the steps of:
a) compacting lignin, wherein the lignin has a moisture content of from 1 wt-% to 45 wt-%, wherein the lignin is agglomerated by means of roll compaction with rolls, wherein the rolls have cavities and wherein a depth of each cavity used in the roll compaction is from 0.1 mm to 10 mm;
b) subjecting the compacted lignin from step a) to a milling step; followed by
c) a sieving step, wherein the product of step b) is subjected to sieving to remove particles having a particle diameter below 100 µm, to produce a final agglomerated lignin with a controlled particle size distribution in which a particle size distribution is governed by a porosity of sieving screens used in the sieving step; and
wherein less than 10 wt-% of the particles retained after step c) have a particle diameter below 100 µm;
d) dissolving the product of step c) in the organic solvent to form the solution;
e) mixing the solution of step d) with the crosslinker to obtain the coating composition.

3. The process according to claim 2, wherein the lignin is agglomerated without addition of any additives.

4. The process according to claim 2, wherein the lignin used in step a) has a moisture content of from 5 wt-% to 10 wt-%.

5. The process according to claim 1, wherein the organic solvent is selected from a group consisting of: ketones, esters, alcohols, glycol ethers, hydrocarbons or ethers or mixtures thereof.

6. The process according to claim 1, wherein the crosslinker is selected from a group consisting of: glycerol diglycidyl ether, polyglycerol diglycidyl ether, polyglycerol polyglycidyl ether, glycerol triglycidyl ether, sorbitol polyglycidyl ether, alkoxylated glycerol polyglycidyl ether, trimethylolpropane triglycidyl ether, trimethylolpropane diglycidyl ether, polyoxypropylene glycol diglycidylether, polyoxypropylene glycol triglycidyl ether, diglycidylether of cyclohexane dimethanol, resorcinol diglycidyl ether, isosorbide diglycidyl ether, pentaerythritol tetraglycidyl ether, ethylene glycol diglycidyl ether, polyethylene glycol diglycidyl ether having 2-9 ethylene glycol units, propylene glycol diglycidyl ether having 1-5 propylene glycol units, diglycidyl-, triglycidyl- or polyglycidyl- ether of a carbohydrate, diglycidyl-, triglycidyl- or polyglycidyl-ester of a carbohydrate, diglycidyl-ether or diglycidyl ester of salicylic acid, vanillic acid, or 4-hydroxybenzoic acid, an epoxidized or glycidyl substituted plant-based phenolic compound or epoxidized plant-based oil, tris(4-hydroxyphenyl) methane triglycidyl ether, N,N-bis(2,3-epoxypropyl)aniline, p-(2,3-epoxypropoxy-N,N-bis(2,3-epoxypropyl)aniline, diglycidyl ether of bis-hydroxymethylfuran, and/or diglycidyl ether of terminal diol having a linear carbon chain of 3-6 carbon atoms, and a crosslinker having functional groups selected from glycidyl amine, diglycidyl amine, triglycidyl amine, polyglycidyl amine, glycidyl amide, diglycidyl amide, triglycidyl amide, polyglycidyl amide, glycidyl ester, diglycidyl ester, triglycidyl ester, polyglycidyl ester, glycidyl azide, diglycidyl azide, triglycidyl azide, polyglycidyl azide, glycidyl methacrylate, diglycidyl methacrylate, triglycidyl methacrylate, or polyglycidyl methacrylate.

7. A process for providing a coating composition on a substrate, the process comprising:
applying the coating composition according to claim 1 on a surface of a substrate.

8. A process for providing a coating on a substrate, the process comprising:
applying a coating composition according to claim 1 on a surface of a substrate; and
curing the substrate to obtain a coating.

9. The process according to claim 8, wherein the substrate is selected from a group consisting of: paper, wood, or metal.

10. A paper, wood or metal coated with the coating composition according claim 1.
